(19) United States
(12) Patent Application Publication
(10) Pub. No.: US 2020/0192153 A1
(43) Pub. Date: Jun. 18, 2020

(54) DISPLAY ASSEMBLY AND ELECTRONIC APPARATUS

(71) Applicant: WUHAN CHINA STAR OPTOELECTRONICS SEMICONDUCTOR DISPLAY TECHNOLOGY CO., LTD., Wuhan (CN)

(72) Inventors: Qingliang TAO, Wuhan (CN); Caiqin CHEN, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/468,007

(22) PCT Filed: Jan. 28, 2019
(86) PCT No.: PCT/CN2019/073391

§ 371 Date: Jun. 10, 2019

(30) Foreign Application Priority Data
Dec. 18, 2018 (CN) 201811555507.8

(51) Int. Cl. G02F 1/1335; G02F 1/1343; G02F 1/1333; B32B 9/00; G06F 1/16

(52) U.S. Cl. CPC G02F 1/133528; G02F 1/13439; G02F 1/133371; B32B 2457/202; G06F 1/1637; B32B 2457/206; B32B 9/00

(57) ABSTRACT

A display assembly and an electronic apparatus include a display layer, configured to display an image; a first electrode layer, disposed on the display layer and including a plurality of first electrode chains; a polarizer, disposed on the first electrode layer; and a second electrode layer, disposed on the polarizer and including a plurality of second electrode chains. The second electrode chains and the first electrode chains are alternately disposed and insulated with each other.

### FIELD OF INVENTION

The present invention relates to the field of display technologies, and in particular, to a display assembly and an electronic apparatus.

### BACKGROUND OF INVENTION

As shown in FIG. 1, a display assembly of an on-cell structure usually includes a display 10 and a touch layer 20. An inter-layer insulation layer 111 is disposed between the display 10 and the touch layer 20. The touch layer 20 is manufactured on the display 10, and is specifically disposed on a polarizer of the display 10.

The current touch layer 20 includes a first electrode layer 21 and a second electrode layer 23. An insulation layer 22 is disposed between the first electrode layer 21 and the second electrode layer 23. A passivation layer 24 is disposed on the second electrode layer 23. A cover glass (not shown in the figure) is disposed on the passivation layer 24.

The current touch layer 20 needs to be provided with an insulation layer and a passivation layer, resulting in a relatively large thickness of the current display assembly.

Therefore, it is necessary to provide a display assembly and an electronic apparatus, so as to resolve the problem existing in the prior art.

### SUMMARY OF INVENTION

An objective of the present invention is to provide a display assembly and an electronic apparatus, so that the thickness of the display assembly can be reduced.

In order to resolve the foregoing technical problem, the present invention provides a display assembly, including:

a display layer, configured to display an image;

a first electrode layer, disposed on the display layer and including a plurality of first electrode chains;

a polarizer, disposed on the first electrode layer, wherein a positive projection area of the polarizer on a horizontal plane is less than a positive projection area of the display layer on the horizontal plane; and

a second electrode layer, disposed on the polarizer and including a plurality of second electrode chains, wherein the second electrode chains and the first electrode chains are alternately disposed and insulated with each other, and a first optical adhesive layer is disposed between the polarizer and the first electrode layer.

The present invention provides a display assembly, including:

a display layer, configured to display an image; a first electrode layer, disposed on the display layer and including a plurality of first electrode chains; a polarizer, disposed on the first electrode layer; and a second electrode layer, disposed on the polarizer and including a plurality of second electrode chains, wherein the second electrode chains and the first electrode chains are alternately disposed and insulated with each other.

In the display assembly of the present invention, a first optical adhesive layer is disposed between the polarizer and the first electrode layer.

In the display assembly of the present invention, a positive projection area of the polarizer on a horizontal plane is less than a positive projection area of the display layer on the horizontal plane.

In the display assembly of the present invention, the display assembly further includes a driver chip, a plurality of first connection lines, and a plurality of second connection lines, wherein the first electrode chains are connected to the driver chip through the first connection lines; and the second electrode chains are connected to the driver chip through the second connection lines.

In the display assembly of the present invention, a cross section structure of the display layer includes a switch array layer, a cross section structure of the switch array layer includes a metal layer, and the metal layer includes a first wire, a second wire, a source, and a drain; the first connection lines are connected to the driver chip through the first wire, and the second connection lines are connected to the driver chip through the second wire.

In the display assembly of the present invention, the display layer is an OLED layer, a cross section structure of the OLED layer including a substrate, as well as a switch array layer, an OLED layer, and a packaging layer that are located on the substrate in sequence; and the first electrode layer is located on the packaging layer.

In the display assembly of the present invention, the display assembly further includes a glass cover plate, wherein the glass cover plate is located on the second electrode layer.

In the display assembly of the present invention, a second optical adhesive layer is disposed between the glass cover plate and the second electrode layer.

In the display assembly of the present invention, the display layer is a liquid crystal display layer.

The present invention further provides an electronic apparatus, including any of the foregoing display assemblies.

In the display assembly and the electronic apparatus of the present invention, a first electrode layer and a polarizer are manufactured on a display layer in sequence, and then a second electrode layer is disposed on the polarizer, thereby omitting an insulation layer, and reducing the overall thickness of the display assembly.

### BRIEF DESCRIPTION OF DRAWINGS

FIG. 1 is a schematic diagram of a structure of the current display assembly.

FIG. 2 is a schematic diagram of a structure of a display assembly according to the present invention.

FIG. 3 is a top plan view of a first electrode layer in FIG. 2.

FIG. 4 is a top plan view of a second electrode layer in FIG. 2.

FIG. 5 is a schematic diagram of the second electrode layer in FIG. 2 and connection of the second electrode layer.

FIG. 6 is a schematic diagram of a structure of a switch array layer in a display layer according to the present invention.

### DETAILED DESCRIPTION OF PREFERRED EMBODIMENTS

The description of the following embodiments is made with reference to the accompanying drawings, and is used to illustrate particular embodiments that can be implemented of the present invention. The directional terms mentioned in the present invention, such as “upper”, “lower”, “front”, “rear”, “left”, “right”, “inner”, “outer”, and “side surface”, are merely directions with reference to the accompanying drawings. Therefore, the used directional terms are used for illustration and comprehension of the present invention, but are not intended to limit the present invention. In the drawings, units with similar structures are represented by using identical reference numerals.

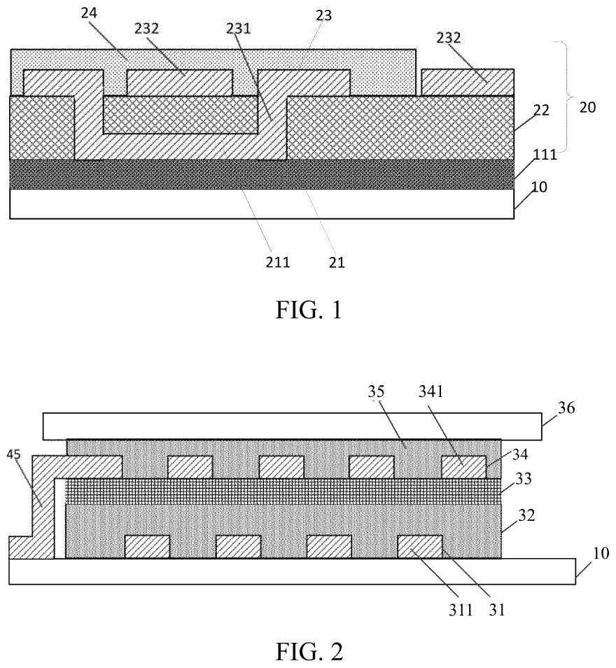

Referring to FIG. 1, in a specific manufacture process, a first electrode layer 21 and a second electrode layer 23 need to be patterned separately, to obtain a touch driving electrode (TX) 211 and a touch sensing electrode (RX) 232. Because the junction between the TX and the RX requires a line-switched connection through a metal bridge 231, an insulation layer 22 further needs to be patterned, to form a connection hole (corresponding to a position of the metal bridge). After that, a passivation layer 24 further needs to be patterned, so that the rightmost touch sensing electrode 232 (a lead of the RX) is exposed. As can be seen, four masks need to be used in the foregoing manufacture procedure; the fabrication process is relatively complex and has relatively high costs.

Referring to FIG. 2 to FIG. 5, FIG. 2 is a schematic diagram of a structure of a display assembly according to the present invention.

As shown in FIG. 2, the display assembly of the present invention includes a display layer 10, a first electrode layer 31, a polarizer 33, and a second electrode layer 34, and may further include a glass cover plate 36.

The display layer 10 is configured to display an image. The display layer 10 may be construed as a display panel on which no polarizer is disposed. A cross section structure of the display layer 10 includes a switch array layer, and the switch array layer includes a plurality of switch elements, that is, thin film transistors.

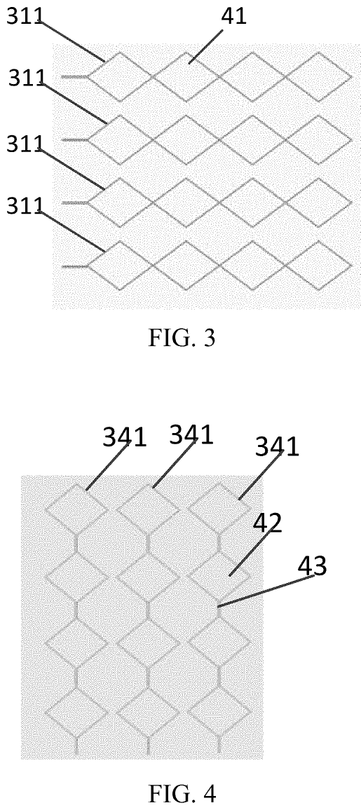

The first electrode layer 31 is disposed on the display layer 10 and includes a plurality of first electrode chains 311. With reference to FIG. 3, the first electrode chains 311 each include a plurality of first electrode patterns 41 electrically connected to each other. The first electrode patterns 41 are arranged in a first direction, for example, arranged in a lateral direction. Two adjacent first electrode patterns 41 adjoin to each other.

In an embodiment, the display layer 10 is a liquid crystal display layer. The liquid crystal display layer includes a first substrate and a second substrate. The second substrate includes a glass substrate, and the first electrode layer 31 is located on the glass substrate.

In another embodiment, the display layer 10 is an OLED layer, and a cross section structure of the OLED layer includes a substrate, as well as a switch array layer, an OLED layer, and a packaging layer that are located on the substrate in sequence. The first electrode layer 31 is located on the packaging layer. That is, the technical solution of the present invention can be applied to a liquid crystal display and an OLED display.

The polarizer 33 is disposed on the first electrode layer 31. To improve flatness of the display assembly and stability of the polarizer, a first optical adhesive layer 32 is disposed between the polarizer 33 and the first electrode layer 31. The first optical adhesive layer 32 is an optically clear adhesive (OCA). The first optical adhesive layer 32 is further used for protecting the first electrode layer 31.

The second electrode layer 34 is disposed on the polarizer 33. With reference to FIG. 4, the second electrode layer 34 includes a plurality of second electrode chains 341. The second electrode chains 341 and the first electrode chains 311 are alternately disposed and insulated with each other. The second electrode chains 341 each include a plurality of second electrode patterns 42 electrically connected to each other. The second electrode patterns 42 are arranged in a second direction, for example, arranged in a vertical direction. Two adjacent second electrode patterns 42 are disposed at an interval, and are connected through a connection bridge 43. For example, two adjacent second electrode patterns 42 are connected through one or more connection bridges 43. In an implementation, each of the first electrode patterns 41 is a touch driving electrode TX, and each of the second electrode patterns 42 is a touch sensing electrode RX.

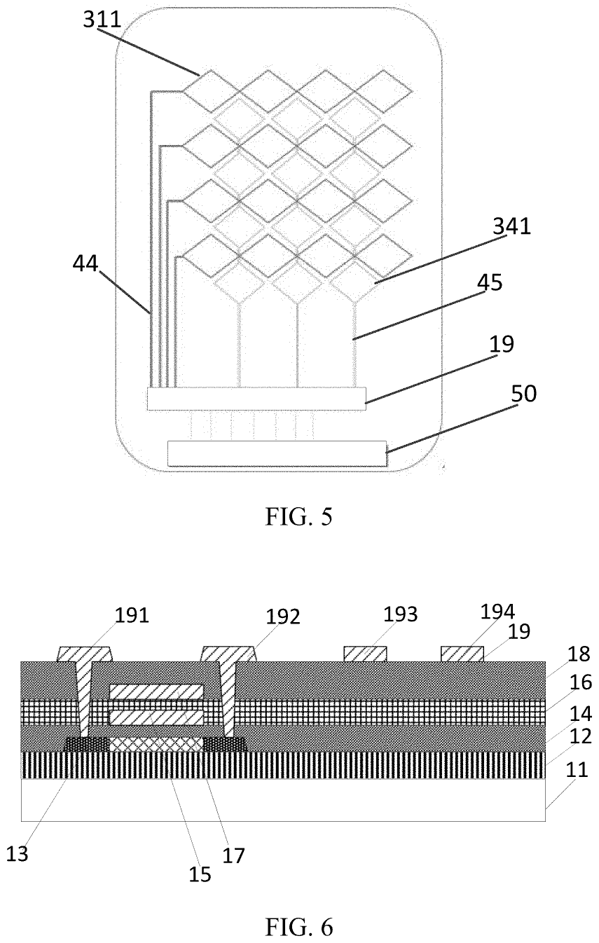

As shown in FIG. 5, the display assembly further includes a driver chip 50, a plurality of first connection lines 44, and a plurality of second connection lines 45. The first connection lines 44 correspond to the first electrode chains 311. The second connection lines 45 correspond to the second electrode chains 341.

The first electrode chains 311 are connected to the driver chip 50 through the first connection lines 44. The second electrode chains 341 are connected to the driver chip 50 through the second connection lines 45.

It can be understood that, the first connection lines 44 are formed at the same time when the first electrode layer 31 is patterned to form the first electrode patterns 41. The connection bridge 43 and the second connection lines 45 are formed at the same time when the second electrode layer 34 is patterned to form the second electrode patterns 42.

With reference to FIG. 6, a cross section structure of the display layer 10 includes a substrate 11, a buffering layer 12, and a switch array layer. A cross section structure of the switch array layer includes a semiconductor layer 13, a first insulation layer 14, a gate 15, a gate insulation layer 16, a metal portion 17, an interlayer insulation layer 18, and a metal layer 19. The metal layer 19 includes a source 191, a drain 192, a first wire 193, and a second wire 194. That is, the first wire 193 and the second wire 194 are located on the same metal layer as the source 191 and the drain 192. While the metal layer 19 is patterned to form the source 191 and the drain 192, the first wire 193 and the second wire 194 are formed. The semiconductor layer 13 is used for forming a channel. A position of the metal portion 17 corresponds to a position of the gate 15.

To improve flatness of pins of the driver chip, the first connection lines 44 are connected to the driver chip 50 through the first wire 193, and the second connection lines 44 are connected to the driver chip 50 through the second wire 194.

To facilitate disposition of connection lines outside a display region, a positive projection area of the polarizer 31 on a horizontal plane is less than a positive projection area of the display layer 10 on the horizontal plane. The display layer 10 has a display region (not shown in the figure), and the positive projection area of the polarizer 31 on the horizontal plane is greater than a positive projection area of the display region on the horizontal plane.

Referring to FIG. 2 again, to improve the touch sensitivity, the glass cover plate 36 is disposed on the second electrode layer 34, that is, the second electrode layer 34 is closer to above the display, to facilitate improving the touch sensitivity. To improve flatness of the display assembly and stability of the glass cover plate, a second optical adhesive layer 35 is disposed between the glass cover plate 36 and the second electrode layer 34. The second optical adhesive layer 35 is further used for protecting the second electrode layer 34. The second optical adhesive layer 35 is also an OCA.

The first electrode layer and the polarizer are manufactured on the display layer in sequence, and then the second electrode layer is disposed on the polarizer, thereby omitting an insulation layer, and reducing the overall thickness of the display assembly.

Secondly, the second electrode layer in the present invention is closer to the cover glass, and therefore the touch sensitivity is improved. In addition, two mask processes are only involved in a manufacture process of the display of the present invention (a mask is essential in a patterning process). Therefore, a manufacture procedure can be simplified, and production costs can be reduced.

The present invention further provides an electronic apparatus that includes any of the foregoing display assemblies.

In the display assembly and the electronic apparatus of the present invention, a first electrode layer and a polarizer are manufactured on a display layer in sequence, and then a second electrode layer is disposed on the polarizer, thereby omitting an insulation layer, and reducing the overall thickness of the display assembly.

In conclusion, although the present invention has been disclosed by using preferred embodiments, the foregoing preferred embodiments are not intended to limit the present invention. A person of ordinary skill in the art can make various changes and modifications without departing from the spirit and scope of the present invention. Therefore, the protection scope of the present invention is subject to the scope defined in the claims.

What is claimed is:

1. A display assembly, comprising:
a display layer, configured to display an image;
a first electrode layer, disposed on the display layer and comprising a plurality of first electrode chains;
a polarizer, disposed on the first electrode layer, wherein a positive projection area of the polarizer on a horizontal plane is less than a positive projection area of the display layer on the horizontal plane; and
a second electrode layer, disposed on the polarizer and comprising a plurality of second electrode chains, wherein the second electrode chains and the first electrode chains are alternately disposed and insulated with each other, and a first optical adhesive layer is disposed between the polarizer and the first electrode layer.

2. The display assembly according to claim 1, further comprising a driver chip, a plurality of first connection lines, and a plurality of second connection lines,
wherein the first electrode chains are connected to the driver chip through the first connection lines; and
the second electrode chains are connected to the driver chip through the second connection lines.

3. The display assembly according to claim 2, wherein the display layer comprises a switch array layer in a cross section of the display layer, the switch array layer has a cross section structure comprising a metal layer, and the metal layer comprises a first wire, a second wire, a source, and a drain;
the first connection lines are connected to the driver chip through the first wire; and
the second connection lines are connected to the driver chip through the second wire.

4. The display assembly according to claim 2, wherein
the first electrode chains each comprise a plurality of first electrode patterns electrically connected to each other, and the first connection lines are formed at the same time when the first electrode layer is patterned to form the first electrode patterns.

5. The display assembly according to claim 2, wherein
the second electrode chains each comprise a plurality of second electrode patterns electrically connected to each other, and the second connection lines are formed at the same time when the second electrode layer is patterned to form the second electrode patterns.

6. The display assembly according to claim 1, wherein the display layer is an organic light-emitting diode display (OLED) layer, a cross section structure of the OLED layer comprises a substrate, as well as a switch array layer, an OLED layer, and a packaging layer that are located on the substrate in sequence, and the first electrode layer is located on the packaging layer.

7. The display assembly according to claim 1, further comprising a glass cover plate, wherein the glass cover plate is located on the second electrode layer.

8. The display assembly according to claim 7, wherein a second optical adhesive layer is disposed between the glass cover plate and the second electrode layer.

9. The display assembly according to claim 1, wherein the display layer is a liquid crystal display layer.

10. A display assembly, comprising:
a display layer, configured to display an image;
a first electrode layer, disposed on the display layer and comprising a plurality of first electrode chains;
a polarizer, disposed on the first electrode layer; and
a second electrode layer, disposed on the polarizer and comprising a plurality of second electrode chains, wherein the second electrode chains and the first electrode chains are alternately disposed and insulated with each other.

11. The display assembly according to claim 10, wherein
a first optical adhesive layer is disposed between the polarizer and the first electrode layer.

12. The display assembly according to claim 10, wherein
a positive projection area of the polarizer on a horizontal plane is less than a positive projection area of the display layer on the horizontal plane.

13. The display assembly according to claim 10, further comprising a driver chip, a plurality of first connection lines, and a plurality of second connection lines, wherein
the first electrode chains are connected to the driver chip through the first connection lines; and
the second electrode chains are connected to the driver chip through the second connection lines.

14. The display assembly according to claim 13, wherein the display layer comprises a switch array layer in a cross section of the display layer, and the switch array layer has a cross section structure comprising a metal layer, and the metal layer comprises a first wire, a second wire, a source, and a drain;
the first connection lines are connected to the driver chip through the first wire; and
the second connection lines are connected to the driver chip through the second wire.

15. The display assembly according to claim 10, wherein the display layer is an organic light-emitting diode display (OLED) layer, a cross section structure of the OLED layer comprising a substrate, as well as a switch array layer, an OLED layer, and a packaging layer that are located on the substrate in sequence; and the first electrode layer is located on the packaging layer.

16. The display assembly according to claim 10, further comprising a glass cover plate, wherein the glass cover plate is located on the second electrode layer.

17. The display assembly according to claim 16, wherein a second optical adhesive layer is disposed between the glass cover plate and the second electrode layer.

18. The display assembly according to claim 10, wherein the display layer is a liquid crystal display layer.

19. An electronic apparatus, comprising a display assembly that comprises:
a display layer, configured to display an image;
a first electrode layer, disposed on the display layer and comprising a plurality of first electrode chains;
a polarizer, disposed on the first electrode layer; and
a second electrode layer, disposed on the polarizer and comprising a plurality of second electrode chains, wherein the second electrode chains and the first electrode chains are alternately disposed and insulated with each other.

20. The electronic apparatus according to claim 19, wherein
a first optical adhesive layer is disposed between the polarizer and the first electrode layer.
